(19) United States
(12) Patent Application Publication
(10) Pub. No.: US 2015/0172434 A1
(43) Pub. Date: Jun. 18, 2015

(54) ON-VEHICLE DEVICE

(71) Applicant: Toshio Kawagishi, Tokyo (JP)

(72) Inventor: Toshio Kawagishi, Tokyo (JP)

(73) Assignee: MITSUBISHI ELECTRIC CORPORATION, Tokyo (JP)

(21) Appl. No.: 14/404,426

(22) PCT Filed: Jul. 17, 2012
(86) PCT No.: PCT/JP2012/068099

§ 371 Date: Nov. 26, 2014

(51) Int. Cl. H04M 1/60; H04W 24/08; H04M 1/725

(52) U.S. Cl. CPC H04M 1/6091; H04M 1/72569; H04W 24/08; H04M 1/7253

(57) ABSTRACT

An object is to provide a technology with which the number of passengers can be obtained and presence or absence of a fellow passenger can thus be determined, at high precision and with a simple configuration. An on-vehicle device is an on-vehicle device installed on a vehicle and includes a wireless communication unit, a communication quality management unit, and a controller. The communication quality management unit measures communication quality of wireless communication for communication devices which are capable of wireless communication with the wireless communication unit. The controller obtains, among the communication devices capable of wireless communication with the wireless communication unit, the number of communication devices whose communication quality is equal to or higher than a predetermined threshold.

### TECHNICAL FIELD

The present invention relates to an on-vehicle device installed on a vehicle like a navigation device.

### BACKGROUND ART

Conventionally, when a driver makes a telephone conversation while driving a vehicle by using a communication device such as a portable telephone, the driver has to perform a steering wheel operation while holding the communication device in hand, whereby it is impossible to perform a quick steering wheel operation. To address this issue, a technology that enables a phone conversation without holding the communication device in hand, that is to say, a hands-free call has been realized on an on-vehicle device such as a navigation device by using a microphone and a speaker on the vehicle instead of a microphone and a speaker of the communication device, respectively.

However, in the case that a hands-free call is performed even when a fellow passenger in addition to the driver is in the vehicle, a content of the phone conversation from the on-vehicle speaker can be heard not only by the driver but also by the fellow passenger. Thus, there arises a problem that privacy of the driver cannot be protected.

To solve this issue, various technologies have been proposed. For example, in Patent Document 1, a technology is disclosed in which a seating sensor for detecting seating of a fellow passenger is provided and, when the seating sensor detects the seating of a fellow passenger, the hands-free call is terminated. Further, for example, in Patent Document 2, a technology is disclosed in which presence or absence of a fellow passenger is determined, based on whether wireless communication between two or more communication devices is detected.

### PRIOR ART DOCUMENTS

### Patent Documents

Patent Document 1: Japanese Patent Application Laid-Open No. H10-203257 (1998)

Patent Document 2: Japanese Patent Application Laid-Open No. 2004-140731

### SUMMARY OF INVENTION

### Problems to be Solved by the Invention

However, with the technology disclosed in Patent Document 1, it is necessary to mount the seating sensor on every sheet on the vehicle, whereby there is a problem that it requires time and cost to mount the seating sensor. On the other hand, with the technology disclosed in Patent Document 2, these time and effort and the like are not required; however, a communication device inside the vehicle and a communication device outside the vehicle are both detected without distinguishing them, whereby there is a problem that the accuracy of determination of presence or absence of a fellow passenger is low.

The present invention has been made in view of the above problems, and an object of the present invention is to provide a technology in which the presence or absence of a fellow passenger can be accurately determined with a simple configuration.

### Means for Solving the Problems

An on-vehicle device according to the present invention is an on-vehicle device installed on a vehicle, the on-vehicle device including: a wireless communication unit; a communication quality management unit which measures, for communication devices capable of wireless communication with the wireless communication unit, communication quality of the wireless communication; and a controller which obtains, among the communication devices capable of wireless communication with the wireless communication unit, the number of communication devices whose communication quality is equal to or higher than a predetermined threshold.

### Effects of the Invention

With the present invention, by obtaining the number of communication devices which have communication quality equal to or higher than the predetermined threshold, the number of communication devices inside the vehicle can be obtained. Thus, it is possible to accurately determine the presence or absence of a fellow passenger, with a simple configuration.

### BRIEF DESCRIPTION OF DRAWINGS

FIG. 1 is a block diagram showing a configuration of an on-vehicle device according to an embodiment 1.

FIG. 2 is a flowchart showing a process on the on-vehicle device according to the embodiment 1.

FIG. 3 is a flowchart showing a process on the on-vehicle device according to the embodiment 1.

FIG. 4 is a flowchart showing a process on the on-vehicle device according to the embodiment 1.

FIG. 5 is a diagram for illustrating an example of how to set a predetermined threshold Qt.

### DESCRIPTION OF EMBODIMENT

### Embodiment 1

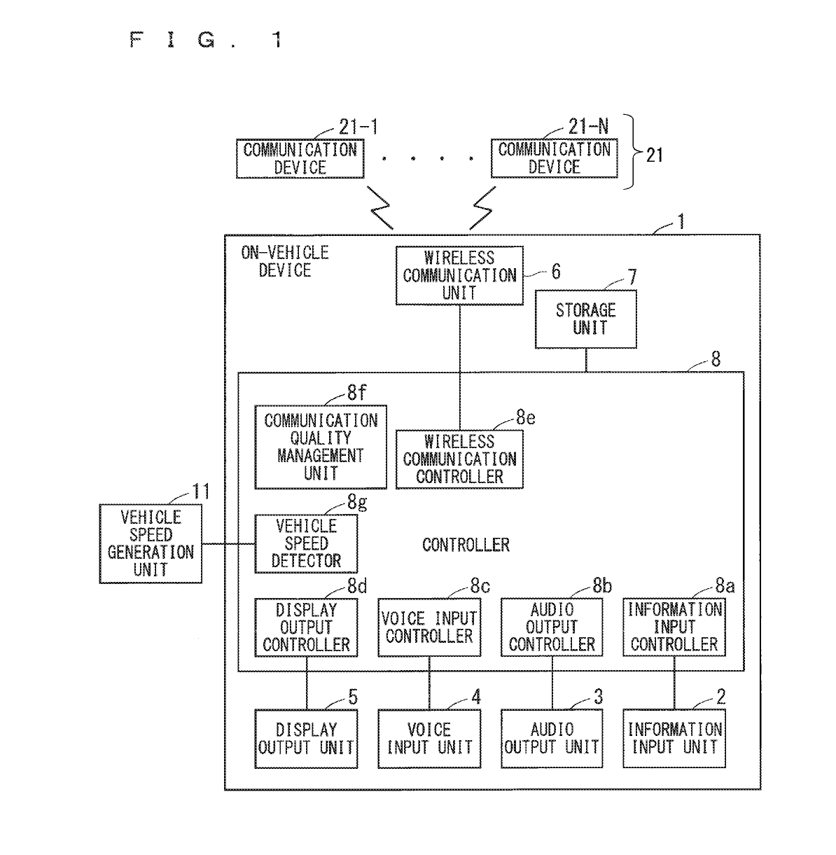

FIG. 1 is a block diagram showing a configuration of an on-vehicle device according to an embodiment 1 of the present invention. An on-vehicle device 1 shown in FIG. 1 is an on-vehicle device installed on a vehicle and includes an information input unit 2, an audio output unit 3, a voice input unit 4, a display output unit 5, a wireless communication unit 6, a storage unit 7, and a controller 8 which comprehensively controls these units. The controller 8 includes an information input controller 8a, an audio output controller 8b, a voice input controller 8c, a display output controller 8d, a wireless communication controller 8e, a communication quality management unit 8f, and a vehicle speed detector 8g. The on-vehicle device 1 including such components as mentioned above compositely has a navigation function, a speech function, and an AV function, for example.

Next, the components of the on-vehicle device 1 will be described in detail.

The information input unit 2 is configured with, for example, a button for accepting an input operation from a user to the on-vehicle device 1, and inputs information from the user and the like. The information input controller 8a processes the information having been input to the information input unit 2, and the controller 8 controls the information input controller 8a, the audio output controller 8b and the like, based on the processed information.

The audio output unit 3 is made up of, for example, a speaker installed in the vehicle, the audio output unit 3 through which voice is output to the user and the like. The audio output controller 8b controls audio output of the audio output unit 3, based on the control of the controller 8.

The voice input unit 4 is made up of, for example, a microphone mounted in the vehicle, the voice input unit 4 through which voice from the user and the like is input. The voice input controller 8c processes the voice having been input to the voice input unit 4 to generate voice information, and the controller 8 controls the information input controller 8a and the audio output controller 8b, based on the voice information.

The display output unit 5 is made up of, for example, a display for displaying various types of information, and displays, to the user and the like, information and the like necessary to the on-vehicle device 1. The display output controller 8d controls the display output of the display output unit 5, based on the control of the controller 8.

The wireless communication unit 6 is made up of, for example, a wireless communication device such as Bluetooth (registered trademark) for short-range communication or a wireless LAN device, and performs wireless communication with communication devices 21 (which are here N communication devices 21-1, 21-2, . . . , 21-N, where N≧1) which are located within a communication range of the wireless communication unit 6. As the communication device 21, there can be assumed a portable telephone, a tablet type information terminal, and the like, for example; however, any types of communication devices can be used as long as they are capable of wireless communication with the wireless communication unit 6.

The wireless communication controller 8e obtains information from a radio signal received by the wireless communication unit 6; and based on the obtained information, the controller 8 controls the information input controller 8a, the audio output controller 8b, and the like. Further, the wireless communication controller 8e generates a radio signal, based on the control of the controller 8, and controls transmission of the radio signal from the wireless communication unit 6.

The storage unit 7 is made up of a storage device for storing various types of information and stores information necessary to the on-vehicle device 1 and other information.

The communication quality management unit 8f measures communication quality for the communication devices 21 which are capable of wireless communication with the wireless communication unit 6, and stores (manages) the measured communication quality. Hereinafter, description will be made assuming that the communication quality management unit 8f measures, as the communication quality, a reception level (reception signal strength) of the radio signal received from the communication device 21. In this case, the higher the reception level (reception signal strength) of the radio signal is, the higher the communication quality is; and the lower the reception level (reception signal strength) is, the lower the communication quality is.

The vehicle speed detector 8g is connected to a vehicle speed generation unit 11 installed on the vehicle. The vehicle speed detector 8g detects a speed of the vehicle, based on a signal (for example, vehicle speed pulse) for detecting a vehicle speed obtained by the vehicle speed generation unit 11.

Although details will be described later, the controller 8 obtains, among the communication devices 21 capable of wireless communication with the wireless communication unit 6, the number of communication devices whose reception levels measured by the communication quality management unit 8f are equal to or higher than a predetermined threshold Qt. Then, the controller 8 obtains, based on the obtained number, the number of passengers (=the total number of driver and fellow passengers) and determines presence or absence of a fellow passenger in the vehicle. Further, based on the determination result of the presence or absence of a fellow passenger, the controller 8 controls a hands-free call and limits the operation to be received by the information input unit.

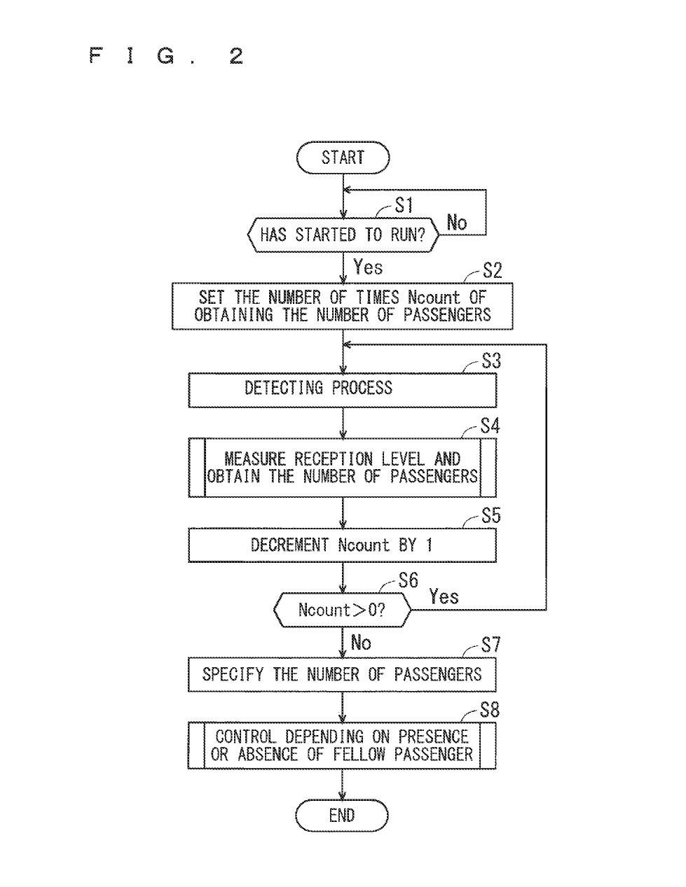

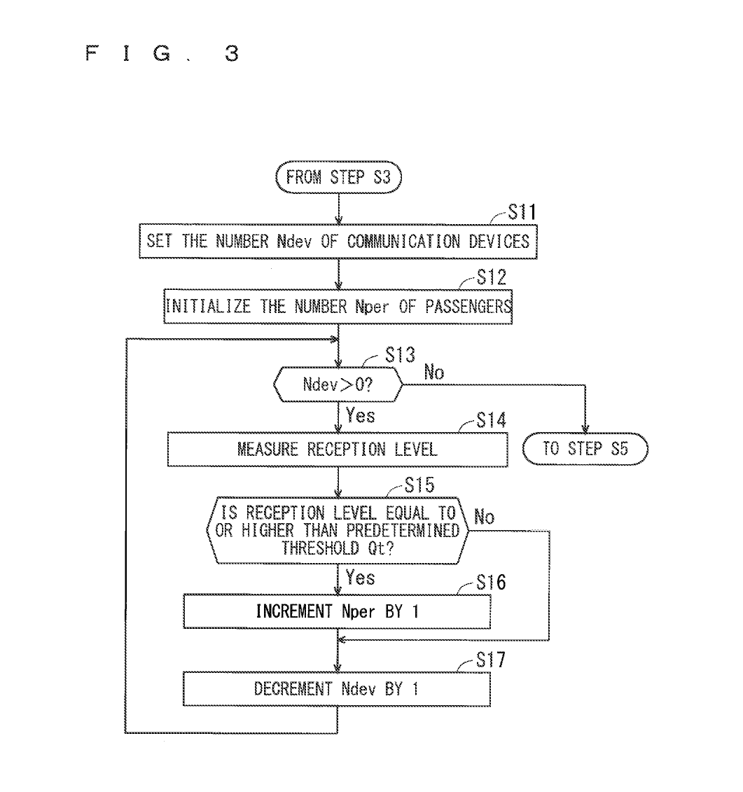

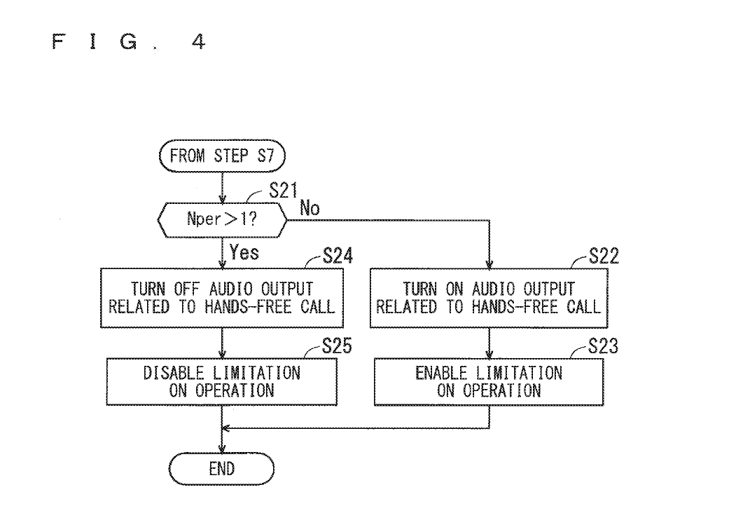

FIG. 2 is a flowchart showing a total process performed by the controller 8, in other words, a total process performed by the on-vehicle device 1 according to the present embodiment; FIG. 3 is a flowchart showing the details of step S4 shown in FIG. 2; and FIG. 4 is a flowchart showing the details of step S8 shown in FIG. 2. Next, the process performed by the controller 8 will be described with reference to these flowcharts.

First, in step S1 shown in FIG. 2, the controller 8 determines whether the vehicle has started to run. Specifically, the controller 8 determines whether the vehicle speed detected by the vehicle speed detector 8g is equal to or higher than a predetermined threshold Vt, and if the vehicle speed is equal to or higher than the predetermined threshold Vt, the controller 8 determines that the vehicle has started to run, and the process goes to step S2. On the other hand, if the above described vehicle speed is lower than the predetermined threshold Vt, the controller 8 determines that the vehicle has not started to run, and the process repeats step S1 until it is determined that the vehicle has started to run.

In step S2, the controller 8 sets the number of times Ncount of obtaining the number of passengers (number of times of obtaining the number of passengers) to a number previously input from the user. Note that description will be made below for the case that the number of times Ncount of obtaining the number of passengers is set to a plurality of times (twice or more) in step S2; however, it should be appreciated that the number of times Ncount may be set to 1.

In step S3, the controller 8 detects all the communication devices 21 located in the communication range of the wireless communication unit 6. Here, because N communication devices 21-1 to 21-N are located in the communication range of the wireless communication unit 6, the N communication devices 21 are detected.

In step S4, the controller 8 controls the communication quality management unit 8f to measure the reception levels of the N communication devices 21 detected in step S3. Then, the controller 8 obtains the number of passengers in the vehicle, based on the measurement result.

Here, the process in step S4 will be described in detail with reference to FIG. 3. First, in step S11, the controller 8 sets the number Ndev of communication devices to the value of the number of communication devices 21 detected in step S3. As described above, if the N communication devices 21 are detected in step S3, the controller 8 sets Ndev=N.

Next, in step S12, the controller 8 initializes the number of passengers as Nper=0.

In step S13, the controller 8 determines whether the number Ndev of communication devices is greater than 0. If it is determined that the number Ndev of communication devices is greater than 0, the process goes to step S14; and if it is determined that the number Ndev of communication devices is equal to or less than 0, the process goes to step S5 of FIG. 2.

In step S14, the controller 8 controls the communication quality management unit 8f to measure the reception level for one of the communication devices 21 detected in step S3. Note that the communication quality management unit 8f measures the reception level for the communication device 21 whose reception level has not been measured, every time when step S14 is executed.

In step S15, the controller 8 determines whether the reception level measured in step S14 is equal to or higher than the predetermined threshold Qt. Although will be described in detail later, the predetermined threshold Qt is set to such a large value of the reception level that cannot be detected in the communication device 21 outside the vehicle. If it is determined that the reception level is equal to or higher than the predetermined threshold Qt, the process goes to step S16; and if it is determined that the reception level is lower than the predetermined threshold Qt, the process goes to step S17.

In step S16, the controller 8 increments, in other words, increases by 1 the value of the number Nper of passengers, and the process goes to step S17.

In step S17, the controller 8 decrements, in other words, decreases by 1 the value of the number Ndev of communication devices, and the process goes back to step S13.

By performing the process as described above, the reception level is measured for each of N communication devices 21 detected in step S3. Then, among the N communication devices 21, the number of communication devices 21 whose reception levels are equal to or higher than the predetermined threshold Qt is obtained. Here, the predetermined threshold Qt is set, as described above, to such a large value of reception level that cannot be detected in the communication device 21 outside the vehicle; thus, by the process shown in FIG. 3, the number of communication devices 21 inside the vehicle is obtained as the number Nper of passengers. In other words, according to the on-vehicle device 1 of the present embodiment 1, counting the number of communication devices 21 outside the vehicle as the number Nper of passengers is prevented, whereby it is possible to accurately obtain the number of passengers.

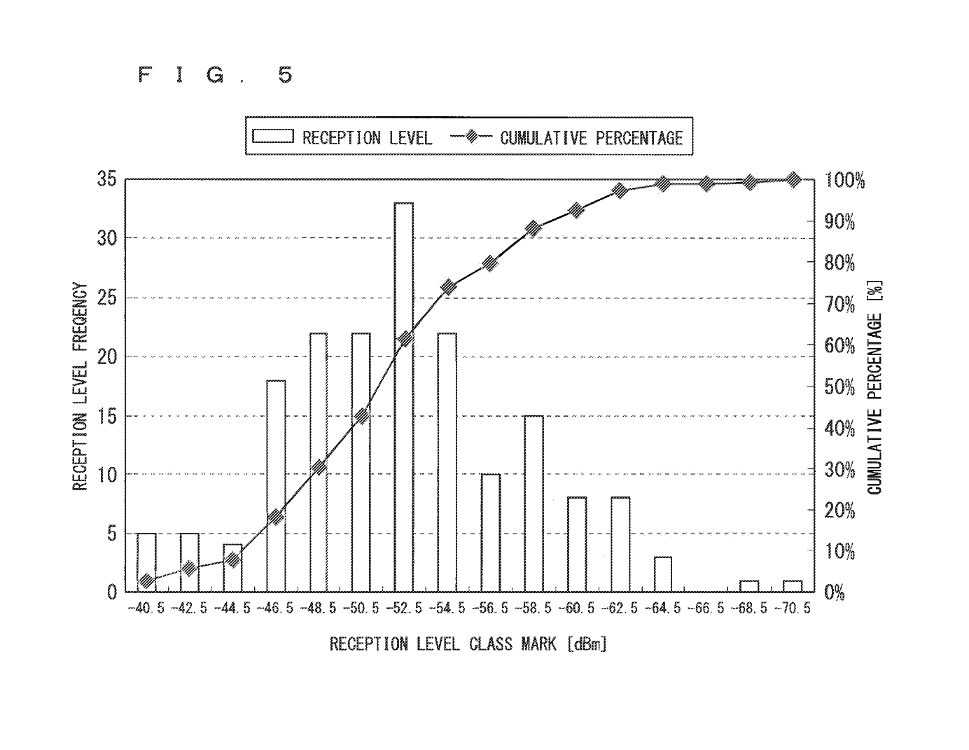

Next, an example of how to set the predetermined threshold Qt will be described. FIG. 5 is a diagram showing distribution of reception levels obtained by placing the communication devices in the vehicle and actually measuring the reception levels. The bar chart represents frequencies of the communication devices corresponding to the ranges of reception level indicated along the horizontal axis. The line chart represents cumulative percentage generated, based on the frequencies of the communication devices.

The distribution of reception levels varies depending on the type of the vehicle, for example; however, if consideration is only given to detecting all the communication devices in the vehicle in the case of the vehicle which has the distribution of reception levels shown in FIG. 5, the predetermined threshold Qt can be set to −70.5 dBm. However, the reception level of −70.5 dBm can possibly be detected in the communication device outside the vehicle, and the number of passengers thus cannot be accurately obtained. To address this issue, if consideration is also given to accurately detecting the number of passengers, the predetermined threshold Qt can be set to the reception level corresponding to the cumulative percentage slightly smaller than 100%, for example, −60.0 dBm at which the cumulative percentage is equal to or higher than 90%.

Getting back to FIG. 2, after step S4, in step S5, the value of the number of times Ncount of obtaining the number of passengers is decremented, in other words, decreased by 1.

In step S6, the controller 8 determines whether the number of times Ncount of obtaining the number of passengers is greater than 0. If it is determined that the number of times Ncount of obtaining the number of passengers is greater than 0, the process goes back to step S3; and if it is determined that the number of times Ncount of obtaining the number of passengers is equal to or smaller than 0, the process goes to step S7.

Here, in the present embodiment 1, because the number of times Ncount of obtaining the number of passengers is set to a plural number of times in step S2 as described above, the processes of steps S3 to S6 are performed a plurality of times. In other words, the measurement of the reception levels by the communication quality management unit 8f and the process for obtaining the number (number of passengers) of the communication devices 21 by the controller 8 are performed a plurality of times.

In step S7, the controller 8 specifies the number of passengers, based on the number of passengers obtained a plurality of times. For example, the controller 8 may set the number of people obtained by averaging the number of passengers obtained a plurality of times as the number of passengers to be specified in step S7, or may set the mode value of the number of passengers obtained a plurality of times as the number of passengers to be specified in step S7.

In step S8, the controller 8 controls, based on the number of passengers (the number of communication devices 21 whose reception levels are equal to or higher than the predetermined threshold Qt) specified in step S7, the hands-free call which uses the communication device (predetermined communication device) of the driver, the audio output unit 3, and the voice input unit 4. In addition, the controller 8 limits, based on the number of passengers specified in step S7, the operation on the information input unit 2. Then, the process shown in FIG. 2 is finished.

Next, with reference to FIG. 4, the process in step S8 will be described in detail. First, in step S21, the controller 8 determines whether the number of passengers specified in step S7 is greater than 1. If the number of passengers is equal to or smaller than 1, the controller 8 determines that there is no fellow passenger in the vehicle, whereby the process goes to step S22; and if the number of passengers is greater than 1, the controller 8 determines that there is a fellow passenger in the vehicle, whereby the process goes to step S24.

In step S22, the controller 8 performs a hands-free call which uses the communication device of the driver, the audio output unit 3, and the voice input unit 4. Then, in step S23, the controller 8 limits the operation on the information input unit 2. In this way, in the case that there is no fellow passenger in the vehicle, the operation on the on-vehicle device 1 is limited, whereby the driver can concentrate on driving. Then, the process is finished.

On the other hand, in step S24, the controller 8 limits the output of the audio output unit 3 with respect to the hands-free call which uses the communication device of the driver, the audio output unit 3, and the voice input unit 4. In other words, in the case that there is a fellow passenger in the vehicle, the audio output related to the hands-free call is turned off, therefore privacy of the driver can be protected. Then, in step S25, the controller 8 releases the limitation on the operation on the information input unit 2, and the process is then finished.

According to the on-vehicle device 1 of the present embodiment 1, by obtaining the number of communication devices whose communication quality (reception level) is equal to or higher than the predetermined threshold Qt, the number of communication devices inside the vehicle can be obtained. Thus, counting the number of communication devices outside the vehicle as the number of passengers is suppressed. Accordingly, the number of passengers can be accurately obtained with a simple configuration, and the presence or absence of a fellow passenger can be consequently determined.

Further, according to the present embodiment 1, when the speed detected by the vehicle speed detector 8g in step S1 is equal to or higher than the predetermined threshold Vt, the communication quality (reception level) is measured in step S4. Here, when the vehicle is running, the possibility of a communication device being outside the vehicle is lower, or the possibility of the communication between a communication device outside the vehicle and the wireless communication unit 6 being interrupted is higher. Therefore, by performing the measurement as described above, counting the number of communication devices outside the vehicle as the number of passengers is further suppressed, whereby the presence or absence of a fellow passenger can be more accurately determined.

Further, according to the present embodiment 1, because the measurement of the communication quality and the process for obtaining the number of communication devices are respectively performed a plurality of times, the number of communication devices in the vehicle can be accurately obtained. As a result, the presence or absence of a fellow passenger can be more accurately determined.

Note that in the above described configuration, the controller 8 or the communication quality management unit 8f may modify such that the predetermined threshold Qt based on the communication quality (reception level) stored in the communication quality management unit 8f. With such a configuration, the predetermined threshold Qt can be set to an appropriate value by learning; thus counting the number of communication device outside the vehicle as the number of passengers can be further suppressed. As a result, the presence or absence of a fellow passenger can be more accurately determined.

Further, in the above described configuration, configuration may be made such that the number m (≧1) of communication device owned by the driver can be previously registered. In this configuration, in step S21, the controller 8 may determine the presence or absence of a fellow passenger, based on whether the number of passengers is greater than m. With such a configuration, the presence or absence of a fellow passenger can be more accurately determined.

Note that in the above description, the communication quality management unit 8f measures the reception signal strength (reception level) as the communication quality. However, without being limited to this, for example, the communication quality management unit 8f may measure a bit error rate as the communication quality. In this case, the higher the bit error rate of the radio signal is, the lower the communication quality is; and the lower the bit error rate is, the higher the communication quality is.

Further, because in the above description, wireless communication is available between the wireless communication unit 6 and the communication device 21, it is assumed that a hands-free call is performed by the wireless communication. However, without being limited to this, a hands-free call may be performed by wire communication.

Further, in the above description, description is made assuming that the on-vehicle device 1 is compositely equipped with the navigation function, the speech function, and the AV function. However, without being limited to this, the on-vehicle device 1 may be equipped with only the navigation function and the speech function.

Note that in the present invention, the embodiment can be appropriately deformed or omitted within the scope of the present invention.

### DESCRIPTION OF THE NUMERALS

1: On-vehicle device
2: Information input unit
3: Audio output unit
4: Voice input unit
6: Wireless communication unit
8: Controller
8f: Communication quality management unit
8g: Vehicle speed detector
21: Communication device

1. An on-vehicle device installed on a vehicle, the on-vehicle device comprising:
a wireless communication unit;
a communication quality management unit which measures, for communication devices capable of wireless communication with said wireless communication unit, communication quality of said wireless communication; and
a controller which obtains, among said communication devices capable of wireless communication with said wireless communication unit, the number of communication devices whose communication quality is equal to or higher than a predetermined threshold.

2. The on-vehicle device according to claim 1, further comprising:
a vehicle speed detector which detects a speed of said vehicle,
wherein said communication quality management unit measures, when the speed detected by said vehicle speed detector is equal to or higher than a predetermined threshold, said communication quality.

3. The on-vehicle device according to claim 2, wherein
the measurement of said communication quality by said communication quality management unit and a process for obtaining the number of said communication devices by said controller are respectively performed a plurality of times.

4. The on-vehicle device according to claim 1, further comprising:
an audio output unit through which voice is output; and
a voice input unit through which voice is input, wherein
said controller controls, based on said number of said communication devices, a hands-free call which uses a predetermined communication device, said audio output unit, and said voice input unit.

5. The on-vehicle device according to claim 1, further comprising:
an information input unit which accepts an input operation, wherein
said controller limits, based on said number of said communication devices, an operation to be accepted by said information input unit.

6. The on-vehicle device according to claim 1, wherein
said communication quality management unit stores said communication quality measured and
said on-vehicle device changes said predetermined threshold to be used in said controller, based on said stored communication quality.
